(19) United States
(12) Patent Application Publication
(10) Pub. No.: US 2001/0045292 A1
(43) Pub. Date: Nov. 29, 2001

(54) Off-center deck for string trimmer

(76) Inventors: Dhananjay Gangakhedkar, Lakewood, OH (US); Timothy D. Dilgard, Ashland, OH (US)

Correspondence Address: Timothy D. Bennett, Fouteenth Floor, One Cascade Plaza, Akron, OH, 44308-1136, US

(21) Appl. No.: 09/802,460

(22) Filed: Mar. 9, 2001

Related U.S. Application Data
(60) Provisional application No. 60/188,045, filed on Mar. 9, 2000.

(51) Int. Cl. A01B 33/00

(52) U.S. Cl. 172/42; 172/27; 172/52

(57) ABSTRACT

A string trimmer is provided with a housing that supports a cutting head. The cutting head includes filaments that are attached thereto at one end for use in cutting associated vegetation. The cutting head is operatively rotated by power supplied from an engine. The cutting head is substantially laterally offset toward on side of the housing member and toward one end of the housing member.

This application claims priority from U.S. Provisional Application Ser. No. 60/188,045, filed on Mar. 9, 2000, titled OFF-CENTER DECK FOR STRING TRIMMER.

### I. BACKGROUND OF THE INVENTION

A. Field of the Invention

This invention relates to the art of walk behind string trimmers and more particularly to the relative position of the string trimmer cutting-head.

B. Description of the Related Art

It is known in the art to provide a walk behind string trimmer having a rotating cutting head and filaments (“strings”) extended therefrom for use in cutting associated vegetation. Known string trimmer cutting heads are disposed along a longitudinal centerline of the string trimmer housing. Such designs are useful for their intended purpose. However, one problem with such designs is that they make it difficult to cut vegetation along the edge of a pathway (or other such edge) where an obstacle or boundary (such as a fence) prevents the trimmer wheels from traversing the edge. It would therefore be advantageous to provide a string trimmer with a cutting head offset toward one side of the trimmer so as to facilitate cutting vegetation along an edge.

### II. SUMMARY OF THE INVENTION

It is the object of the present invention to provide a vegetation-cutting device having a housing (deck) and a cutting head where the cutting head is disposed at a first side and at a first end of the housing.

It is another object of the present invention to provide a string trimmer with a mower deck having a cutting head disposed at a first side and at a first end of the mower deck.

In accordance with the present invention, there is provided a string trimmer having a housing member. Ground engaging wheels are attached to the housing member for use in providing mobility to the string trimmer. A steering handle is fixedly attached to the housing member and extended upwardly therefrom allowing an operator to guide the string trimmer along a desired path. The string trimmer also includes a cutting head rotatably attached to the housing member and cutting filaments fixedly attached to the cutting head. The string trimmer includes an engine that is received by and fixedly attached to the housing member. The engine has an output that is communicated to the cutting head via a belt for use in rotating the cutting head at sufficient speeds to cause the filaments to cut the associated vegetation. The cutting head is disposed substantially at a first side and at a first end of the housing member.

Other objects and advantages of the invention will appear from the following detailed description of the preferred embodiment of the invention with reference being made to the accompanying drawings.

### III. BRIEF DESCRIPTION OF DRAWINGS

The invention may take physical form in certain parts and arrangement of parts, a preferred embodiment of which will be described in detail in this specification and illustrated in the accompanying drawings which form a part hereof and wherein:

FIG. 1 is a front perspective view of the string trimmer.

FIG. 2 is a bottom perspective view of the string trimmer.

FIG. 3 is a bottom perspective view of the string trimmer.

FIG. 4 is a cutaway view of the cutting head and pulley assembly.

FIG. 4a is a side view of the cutting head and pulley assembly.

### IV. DETAILED DESCRIPTION OF THE INVENTION

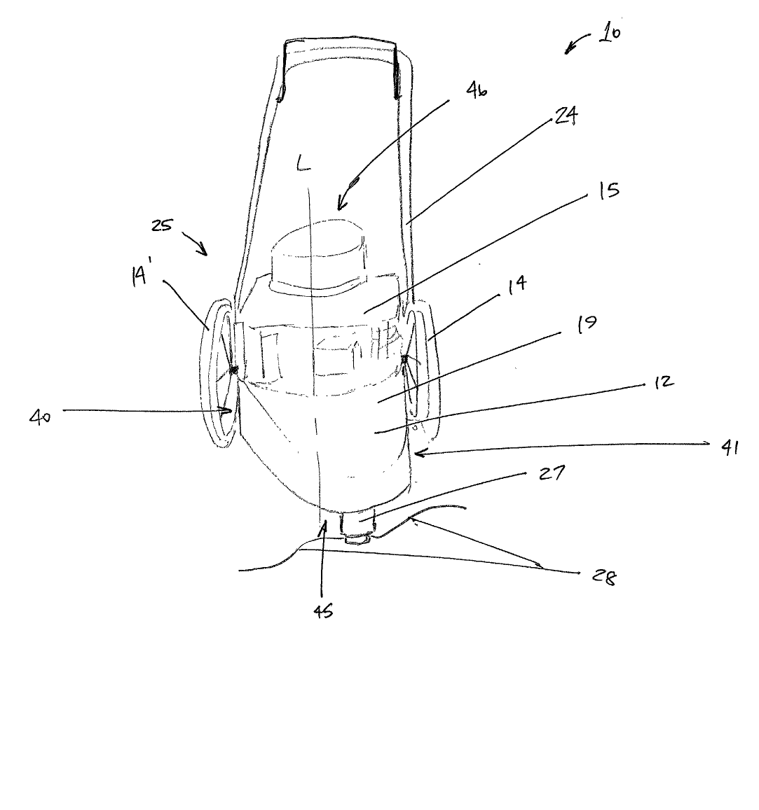

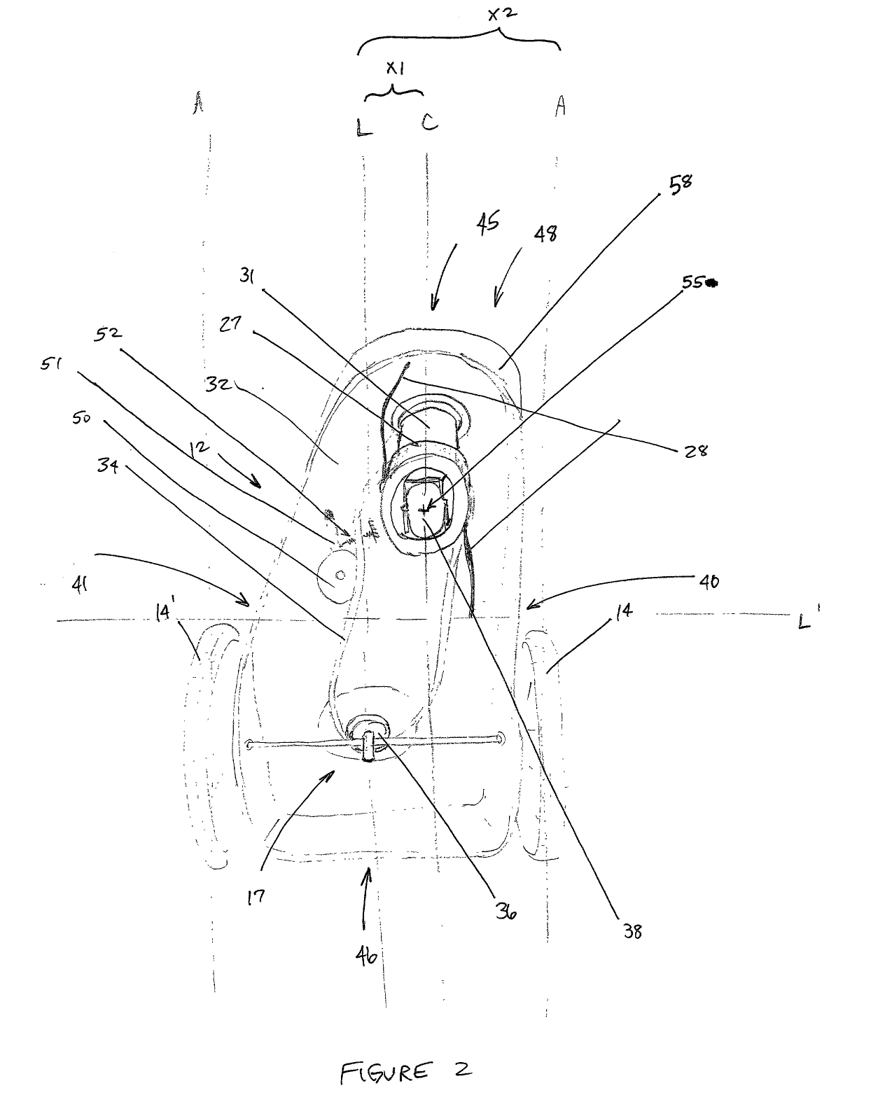

Referring now to the drawings wherein the showings are for purposes of illustrating a preferred embodiment of the invention only and not for purposes of limiting the same, FIG. 1 depicts a walk behind string trimmer shown generally at 10. The string trimmer 10 includes a housing member 12 that supports the components of the string trimmer 10. In this manner, the housing member 12 serves as a frame or a support structure for the string trimmer 10. Ground engaging wheels 14, 14′ are rotatably attached to the housing member 12, one on each side of the housing member 12. In the preferred embodiment, the wheels 14, 14′ share a common axle. However, any means of operatively connecting the wheels 14, 14′ to the housing member 12 may be chosen with sound engineering judgment. An engine 15 is fixedly attached to the top surface 19 of the housing member 12 and provides a power output shaft 17, shown clearly in FIG. 2 and discussed further in subsequent paragraphs. A steering handle 24 has a furcated end 25 that is fixedly connected to the housing member 12 via bolts. This allows an operator to guide the string trimmer 10 along a desired path. In the preferred embodiment, the engine 15 does not provide power to the ground engaging wheels 14, 14′. However, an alternate embodiment is contemplated wherein the drive wheels 14, 14′ are power by the engine 15. A cutting head 27 is rotatably attached with respect to the housing member 12. The cutting head 27 includes flexible cord-like filaments 28 extending outwardly from the cutting head 27 for use in cutting associated vegetation, which will be further discussed in subsequent paragraphs.

With reference to FIGS. 1 and 2, the housing member 12 receives the cutting head 27. In the preferred embodiment, a rigid shaft member 31, is fixedly attached to and extends from a bottom surface 32 of the housing member 12. The cutting head 27 is received onto the shaft member 31 and is rotatably attached thereto via a bearing member, not shown. In this manner, the cutting head 27 is free to rotate about the shaft 31. The power output shaft 17 extends from the engine 15 below the bottom surface 32 of the housing member 12 and receives a pulley 36 onto which is connected a pulley belt 34. The pulley belt 34 is operably communicated to the cutting head 27 for use in rotating the cutting head 27. In other words, the engine 15 transfers rotational power to the cutting head 27 via the belt 34. An idler pulley 50 is pivotally attached to the bottom surface 32 of the housing member 12 via idler shaft 51. A spring 52 is fixedly attached at a first end to the bottom surface 32 of the housing member 12 and is fixedly attached at a second end to the idler shaft 51. In this manner, the spring 52 biases the idler pulley 50 into engagement with the pulley belt 34 for use in taking up slack in the pulley belt 34 during normal operation. In that pulleys, belts and cutting heads are well known in the art, no further explanation will be offered at this point. The engine 15 rotates the cutting head 27 with sufficient rotational speed and torque so that the flexible cord-like filaments 28, which are fixedly attached at a first end to the cutting head 27 and extending therefrom at a predetermined length, may cut the associated vegetation when contacted therewith.

With continued reference to FIG. 2, a third ground engaging wheel 38 is shown rotatably attached with respect to the shaft 31. The third ground engaging wheel 38 is disposed between the cutting head 27 and the associated ground and may rotate about the longitudinal axis of the shaft 3 1. In the preferred embodiment, the third ground engaging wheel 38 is a caster wheel. However, any type of rotating wheel member may be chosen with sound engineering judgment. In this way, the cutting head 27 is prevented from contacting the ground, which may impede operation of the cutting head 27. The third ground engaging wheel 38 also assists the operator in maneuvering the string trimmer 10 about the associated turf.

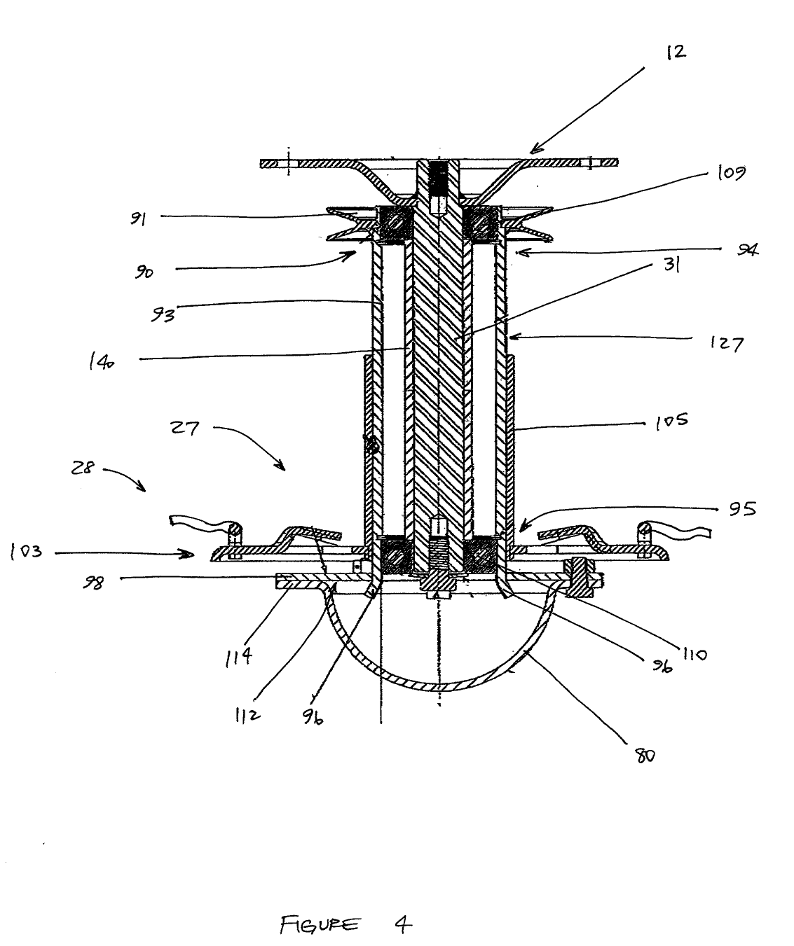

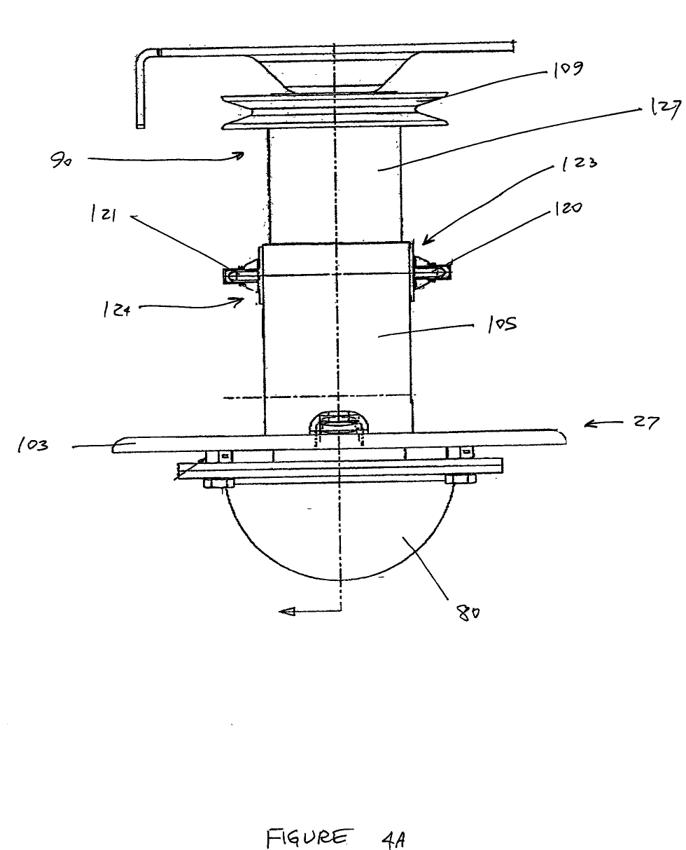

Referring now to FIG. 4, another embodiment is presently discussed where a ground engaging skid member 80 is disposed between the cutting head 27 and the associated ground. In this embodiment, the shaft member 31 is shown rigidly attached to the housing member 12 and extends vertically downward toward the associated ground as previously discussed. A pulley assembly 90 is received onto the shaft member 31 and comprises a pulley member 91, which receives pulley belt 34, and a tube member 93, where the tube member 93 is rigidly connected to the pulley member 91 at a first end 94. At the distal end 95 of the tube member 93, four tabs 96 extend therefrom and are flared or bent radially outward after being inserted into four corresponding slots, not shown, fashioned in a generally disk-shaped cap plate 98. In this way, torque is transmitted from the pulley member 91 through the tube member 93 and to the cap plate 98. The tube member 93 is received onto the shaft member 31 and is supported thereon for rotation about the shaft member 31 by bearings 109, 110. It is noted that a cylindrical spacer 140 may be received onto shaft member 31 and disposed between bearings 109, 110 as shown in FIG. 4 for maintaining alignment of the components of the pulley assembly 90. A hemispherically shaped skid member 80 includes a flange section 114 that is bolted to the lower face 112 of the cap plate 98 with the concave portion of the skid member 80 facing upward or into the cap plate 98. In this manner, the skid member 80 rotates in synchronous with the pulley assembly 90 during operation of the string trimmer 10. Resultantly, the skid member 80 prevents the cutting head 27 from contacting the associated ground during use of the string trimmer 10.

With reference to FIG. 4 and 4a, the cutting head 27 includes a disk portion 103 that extends radially outward from a cylinder portion 105. The disk portion 103 has attached thereto the cord-like filaments 28, which are used in cutting the associated vegetation. The cylinder portion 105 is longitudinally shorter than the tube member 93 and has an inner diameter slightly larger than the outer diameter of the tube member 93. In this way, the cylinder portion 105 is received onto the tube member 93 and may be longitudinally adjusted thereon. It is noted at this point that the cutting head 27 must be assembled onto the tube member 93 prior to attaching cap plate 98 or the skid member 80, since the flaring or bending of the tabs 96 may subsequently prevent the cylinder portion 105 from being received onto the tube member 93. Screw fasteners 120, 121, shown in FIG. 4a, are received into threaded holes 123, 124 fashioned in the cylinder portion 105 of the cutting head 27. When sufficiently tightened, the screw fasteners 120, 121 engage the outer surface 127 of the tube member 93 and prevent the cutting head 27 from moving longitudinally along the length of the tube member 93. In this manner, the operator may loosen the screw fasteners 120, 121, adjust the position of the cutting head 27 longitudinally along the tube member 93 and retighten the screw fasteners 120, 121 to change the cutting height of the cutting head 27. Consequently, the cutting head 27 has infinite position adjustment within the range limited by the ends 94, 95 of the tube member 93 and the length of the cylinder portion 105. Therefore, the cutting head 27 is received by and may selectively be fixedly secured to the pulley assembly 90, so that when rotational power from the pulley belt 34 is transferred to the pulley assembly 90, rotational power, torque is likewise transferred to the cutting head 27 for use in severing associated vegetation.

With continued reference to FIGS. 1 and 2, the housing member 12 is generally oblong having first and second sides 40, 41 and first and second ends 45, 46. The first and second ground engaging wheels 14, 14′ each define first and second planes respectively, as shown by lines A, A′ in FIG. 2. As shown, the planes A, A′ extend generally radially from the wheels 14, 14′ and generally perpendicular from the axes of the wheels 14, 14′. A centerline axis L is defined as being parallel and equidistant from each of the two planes A, A′. In the preferred embodiment, the second side 41 of the housing member 12 at the first end 45 tapers toward an apex 48. The apex 48 is laterally offset from the centerline axis L of the oblong housing member 12 toward the first side 40 of the housing member 27. The cutting head 27 is disposed on the housing member 12 so as to be aligned longitudinally with the apex 48. In this manner, the cutting head 27 is laterally offset toward the first side 40 of the housing member 12. This alignment facilitates ease of cutting vegetation along a desired pathway having a boundary. The cutting head 27 may also be disposed toward the first end 45 or the apex 48 of the housing member 12, which in the preferred embodiment lies forward of a transverse centerline L′ of the housing member 12. In this position, the cutting head 27 is received within the apex 48 of the housing member 12. In this manner, the cutting head 27 is located in a single quadrant of the housing member 12. In an alternate embodiment, the cutting head 27 may be located in any respective quadrant of the housing member 12 that is chosen with sound engineering judgment.

With continued reference to FIGS. 1 and 2, the cutting head 27 has a center 55 through which passes a centerline C, shown clearly in FIG. 2. The centerline C is parallel to both centerline L and to planes A, A′. The distance from centerline L to centerline C of the cutting head 27 is labeled X1. Similarly, the distance from the centerline L to the plane designated by A is labeled X2. A ratio exists, X1/X2, which defines the position of the cutting head 27 with respect to plane A. In the preferred embodiment, the ratio X1/X2, is greater than 0.25. In this manner, the string trimmer 10 is a “left-sided” string trimmer because the cutting head 27 is disposed substantially toward the left of the string trimmer 10 when the operator is standing at the steering handle 24. In an alternate embodiment, the cutting head 27 may be disposed substantially toward the right side of the string trimmer 10, further called a “right handed” string trimmer.

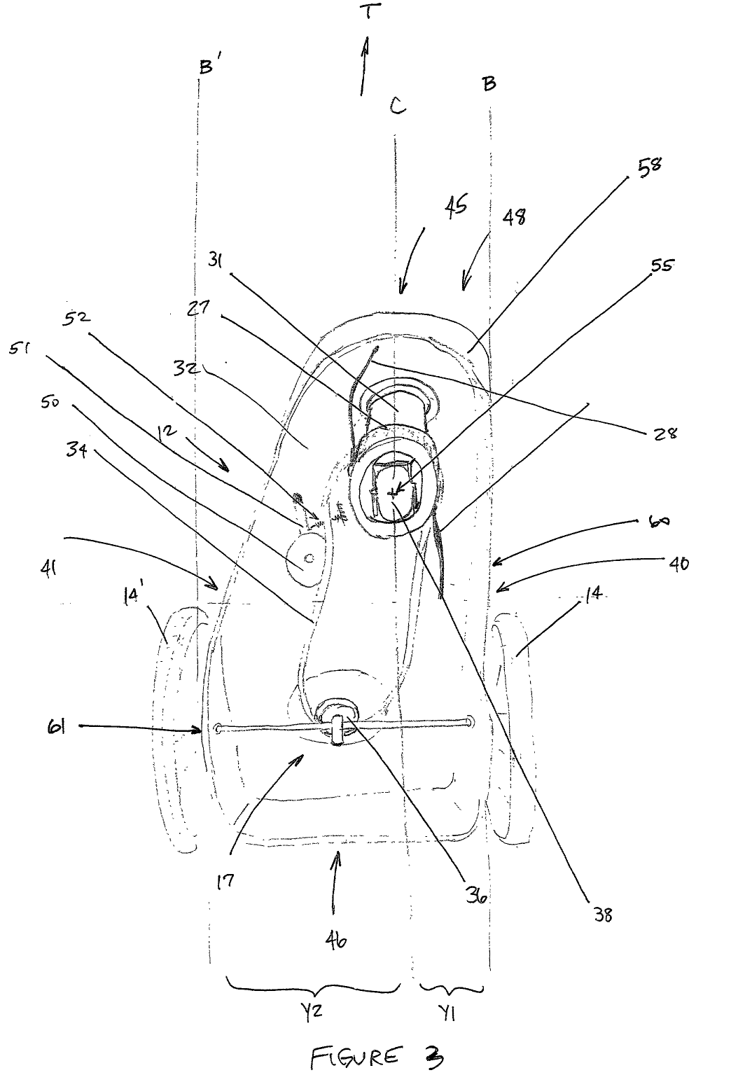

Referring to FIGS. 1 and 3, the previous discussion related the position of the cutting head 27 to the ground engaging wheels 14, 14′. It is also important to relate the offset position of the cutting head 27 to the outermost edges of the housing member 12, which may be a deck 58. In FIG. 3, the first side 40 of the string trimmer 10 has an outermost edge 60. A plane B is defined as being parallel to the direction of travel designated by the arrow T, of the string trimmer 10 and intersecting the outermost edge 60 of the first side 40 of the housing member 12. In a similar manner, plane B′ is parallel to the direction of travel and intersects the outermost edge 61 of the second side 41. The distance from the plane B to the centerline C is labeled Y1. The distance from the plane B′ to the centerline C is labeled Y2, wherein Y2 is greater than Y1, which defines a “left handed” string trimmer 10. An alternate embodiment is contemplated where Y1 is greater than Y2, defining a “right handed” string trimmer. A ratio is defined, Y1/Y2 which relates the lateral position of the cutting head 27 to the sides of the housing member 12. In the preferred embodiment, the ration Y1/Y2 is less than 0.9. In this manner, the lateral position of the cutting head 27 is related only to the configuration of the housing member 27. It is noted that the housing member 12 may be any support structure chosen with sound engineering judgment that functionally supports the cutting head 27.

With reference to FIG. 1, 2 and 3, operation of the string trimmer 10 will now be discussed. With the cutting head 27 laterally offset toward the left side of the string trimmer 10, an operator may align the left edge 60 of the housing member 12 adjacent to a barrier defining a pathway along which it is desired to cut associated vegetation such as grass. After turning on the string trimmer 10, the operator may push the sting trimmer 10 along a trajectory parallel to that of the pathway. In this manner, a “left-handed” string trimmer eliminates the operator from repeatedly transversely maneuvering a string trimmer in and out of the vegetation pathway. Therefore it is clearly shown from the aforementioned description that the offset cutting head 27 of the string trimmer 10 provides an operator with the ability to conveniently trim associated vegetation along a pathway having a boundary that prevents a string trimmer from straddling the desired region of vegetation to be cut.

While specific embodiments of the invention have been described and illustrated, it is to be understood that these embodiments are provided by way of example only and that the invention is not to be construed as being limited thereto but only by proper scope of the following claims.

Having thus described the invention, it is now claimed:

What is claimed is:

1. A string trimmer, comprising:
a housing member;
an engine operatively attached to said housing member;
a first ground engaging wheel operatively attached to said housing member, said first ground engaging wheel having a first axis and defining a first plane perpendicular to said first axis;
a second ground engaging wheel operatively attached to said housing member, said second ground engaging wheel having a second axis and defining a second plane perpendicular to said second axis, said first plane being substantially parallel to said second plane;
wherein said first and second ground engaging wheels define a centerline axis that is parallel to and equidistant between said first and second planes;
a cutting head operatively communicated with said engine, said cutting head rotatably attached with respect to said housing member;
at least a first filament operatively extending from said cutting head for use in cutting associated vegetation; and,
wherein said cutting head is disposed substantially laterally offset from said centerline axis.

2. The string trimmer of claim 1, wherein said cutting head is disposed laterally offset from said centerline axis at a distance X1, and,
wherein said first ground engaging wheel is offset from said centerline at a distance X2, and,
wherein said ratio X1/X2 is greater than 0.25.

3. The string trimmer of claim 2, further comprising at least a third ground engaging wheel juxtaposed between said cutting head and the associated ground.

4. The string trimmer of claim 3, wherein said housing member is a deck.

5. The string trimmer of claim 4, wherein said mower deck has first and second ends that lie on said center axis, and,
wherein said cutting head is disposed substantially at said first end of said housing member.

6. The string trimmer of claim 5, wherein said second end of said deck includes first and second sides, wherein said first and second sides of said second end of said mower deck are substantially parallel, and,
wherein said first end of said mower deck includes first and second sides, said first side of said first end being substantially collinear with said first side of said second end, said second side of said first end being acutely angled with respect to said second side of said second end.

7. The string trimmer of claim 6, wherein said first and second sides of said first end of said mower deck form an apex, and,
wherein said apex is substantially laterally offset from said center axis.

8. The string trimmer of claim 7, wherein said first and said at least a second ground engaging wheel are operatively attached to said second end of said string trimmer.

9. The string trimmer of claim 2, further comprising a skid member juxtaposed between said cutting head and the associated ground.

10. A string trimmer, comprising:
a housing member having first and second sides, said first side of said housing member having a first outermost edge intersecting a first plane, said second side of said housing member have a second outermost edge intersecting a second plane, wherein said first and second planes are substantially parallel to a forward direction of travel of said string trimmer;
at least a first ground engaging wheel operatively attached to said housing member;
an engine operatively attached to said housing member;
a cutting head operatively communicated with said engine, said cutting head rotatably attached with respect to said housing member, wherein said cutting head is disposed substantially laterally toward said first plane; and, at least a first filament operatively extended from said cutting head.

11. The string trimmer of claim 10, wherein said cutting head is disposed a distance Y1 from said first plane, wherein said cutting head is disposed a distance Y2 from said second plane, and,
wherein the ratio of Y1/Y2 is less than 0.9.

12. A method of cutting associated vegetation along the edge of an associated boundary, the steps comprising:
providing a string trimmer with a housing member having first and second sides, the first side of the housing member having a first outermost edge intersecting a first plane, the second side of the housing member having a second outermost edge intersecting a second plane, wherein the first and second planes are substantially parallel to a forward direction of travel of the string trimmer;
providing the string trimmer with at least a first ground engaging wheel operatively attached to the housing member, an engine operatively attached to the housing member, and a cutting head including at least a first filament operatively extended from the cutting head operatively communicated with the engine, wherein the cutting head is disposed substantially laterally toward the first plane;
aligning the first side of the housing member with respect to the associated boundary;
maneuvering the string trimmer such that the first plane remains substantially parallel to the associated boundary while the associated vegetation is cut.
